(19) United States
(12) Patent Application Publication
(10) Pub. No.: US 2008/0186243 A1
(43) Pub. Date: Aug. 7, 2008

(54) VSWR improvement for bicone antennas

(75) Inventors: Donald N. Black, Cumming, GA (US); John D. Voss, Cumming, GA (US); Terence D. Newbury, Hoschton, GA (US)

Correspondence Address: KING & SPALDING LLP, 1180 PEACHTREE STREET, ATLANTA, GA, 30309-3521, US

(73) Assignee: EMS Technologies, Norcross, GA (US)

(21) Appl. No.: 12/012,879

(22) Filed: Feb. 6, 2008

Related U.S. Application Data
(60) Provisional application No. 60/899,806, filed on Feb. 6, 2007.
(60) Provisional application No. 60/899,813, filed on Feb. 6, 2007.

(51) Int. Cl. H01Q 13/04; H01Q 13/02

(52) U.S. Cl. 343/773; 343/772

(57) ABSTRACT

A broadband bicone antenna system supports improved VSWR operation of a high-impedance bicone antenna having a reduced aperture size, high input impedance at the central vertex of the cones, one or more pattern tuning filters associated with the cones, and input filtering for frequency selective impedance matching. Pattern tuning filters can improve the radiation pattern at different frequencies by controlling the electrical length of the antenna in response to the frequency components of the associated wideband signal. Impedance matching input filters can improve the signal matching to couple radio frequency energy into the antenna system from a feed line. Mutual tuning of the pattern tuning filters; the impedance matching input filters; and the impedance of the bicone antenna itself can improve the overall voltage standing wave ratio (VSWR) performance of the bicone antenna system over a broad range of operating frequencies.

### RELATED APPLICATIONS

This patent application claims priority under 35 U.S.C. §119 to U.S. Provisional Patent Application No. 60/899,806, entitled “Low Frequency VSWR Improvement for Bicone Antennas,” filed Feb. 6, 2007 and to U.S. Provisional Patent Application No. 60/899,813, entitled “Frequency Control of Electrical Length for Bicone Antennas,” filed Feb. 6, 2007. The complete disclosure of the above-identified priority applications is hereby fully incorporated herein by reference.

This patent application is related to the co-assigned U.S. patent application entitled “Frequency Control of Electrical Length for Bicone Antennas,” filed on the same day as the present patent application, and having an unassigned patent application serial number.

### FIELD OF THE INVENTION

The present invention relates to an ommi-directional broadband bicone antenna and more specifically to a bicone antenna with increased characteristic impedance and filters for improved voltage standing wave ratio (VSWR) performance and radiation pattern performance. Filter elements can control input impedance of the bicone antenna for a given characteristic impedance with all filtering elements in place.

### BACKGROUND

A bicone antenna is generally an antenna having two conical conductors where the conical elements share a common axis and a common vertex. The conical conductors extend in opposite directions. That is, the two flat portions of the cones face outward from one another. The flat portion of the cone can also be thought of as the base of the cone or the opening of the cone. The flat portion, or opening, of a cone is at the opposite end of the cone from the vertex or point of the cone. Bicone antennas are also called biconical antennas. Generally, a bicone antenna is fed from the common vertex. That is, the driving signal is applied to the antenna by a feed line connected at the antenna's central vertex area.

Positioning two cones so that the points (or vertices) of the two cones meet and the openings (or bases) of the two cones extend outward (opposite one another) results in a bowtie-like appearance.

Generally, bicone antennas support a wide bandwidth, but the low end of the operating frequency range is limited by the aperture size of the antenna, which is the overall length of the antenna along the bicone surface. The relationship between aperture size and frequency operation is generally inverse. That is, operation at a lower frequency requires a larger bicone antenna. More specifically, a traditional bicone antenna requires an aperture size of about one half of the longest operating wavelength. The longest wavelength is related to the lowest operating frequency by the wave velocity relationship, “speed of light=wavelength×frequency” where the speed of light is approximately 300,000,000 meters per second.

Lower frequency operation suggests a bicone antenna with increased electrical length. Increased length often means increased width. At the low frequency limit of a given bicone antenna geometry, an electrically short antenna generally appears more capacitive. Thus, it is often difficult to maintain a low VSWR (voltage standing wave ratio) at the lower operating frequencies. This translates into reduced matching and thus poor signal coupling into the antenna.

In contrast, higher frequency operation suggests a smaller electrical length. While a bicone antenna with increased length will operate at these higher frequencies, the resulting radiation pattern is generally less effective as more energy is directed upward than out along the horizon.

Accordingly, there is a need in the art for an omni-directional bicone antenna having increased impedance, frequency selective pattern turning, and frequency selective impedance matching.

The improved bandwidth and pattern performance of an antenna having both a long electrical length for low frequency operation and a reduced electrical length during high frequency operation is limited by the input impedance of the antenna. The input impedance is not always well matched to a transmission line. Improving this match increases signal coupling to the antenna and provides the benefit of better performance.

Accordingly, there is a need for a means to improve the match between a transmission line and an omni directional bicone antenna having both a long electrical length for low frequency operation and a reduced electrical length during high frequency operation.

### SUMMARY OF THE INVENTION

The present invention can comprise a broadband bicone antenna capable of supporting frequency selective impedance matching as well as frequency selective control of the electrical length of the antenna. The antenna may have a reduced aperture size, high input impedance at the central vertex of the cones, one or more pattern tuning filters associated with the cones, and input filtering for frequency selective impedance matching.

A view of the level of impedance match for a communications system may be obtained from the system's standing wave ratio (SWR). SWR is the ratio of the amplitude of a partial standing wave at an anti-node (maximum) to the amplitude at an adjacent node (minimum). SWR is usually defined as a voltage ratio called the VSWR, for voltage standing wave ratio. The voltage component of a standing wave in a uniform transmission line consists of the forward wave superimposed on the reflected wave and is therefore a metric of the reflections on the transmission line. Reflections occur as a result of discontinuities, such as an imperfection in an otherwise uniform transmission line, or when a transmission line is terminated with a load impedance other than its characteristic impedance. Improved VSWR performance provided by aspects of the present invention may improve signal coupling into the antenna, largely by reducing reflected power.

An aspect of the present invention supports input filtering for frequency selective impedance matching and thus improved VSWR characteristics. Such filtering may be provided by a conductive taper positioned as the center conductor of a coaxial feed mechanism. The inside of one of the cones, typically the “bottom” cone, can serve as the outside conductor (or shielding conductor, or return) of such a tapered filter. Other input filter mechanisms may include lumped filter elements, shaped conductive filter structures, passive filters, or active filters. The input filter can support a complex-to-complex impedance matching that varies with operating frequency to support the desired matching of input signals into the antenna.

Another aspect of the present invention supports a bicone antenna having a reduced aperture size achieved by reducing the cone angle. While reduction in cone angle can increase the impedance of the cones, impedance matching at an input filter can support interfacing to the high impedance characteristic exhibited by the bicone antenna. This aspect can help control antenna size in both the length and width dimensions.

Another aspect of the present invention supports a bicone antenna with radiation pattern tuning filters. Such filters can provide frequency selective control of the electrical length of the antenna and allow the antenna to exhibit two or more different electrical lengths, where each length depends upon the operating frequencies of the signals. The electrical length of the bicone antenna may be reduced in response to higher operating frequencies. Such reduction in electrical length at higher frequencies can provide improved antenna radiation patterns for the antenna. In contrast, the electrical length of the bicone antenna may be increased in response to low frequency operation. Simultaneous operation of the bicone antenna at varied electrical lengths for varied signal frequencies can achieve improved broadband performance of the antenna. That is, the bicone can provide a single aperture antenna with improved performance characteristics at two or more diverse frequency bands.

Filters integrated into the bicone antenna can provide pattern tuning and frequency selective control of the electrical length of the bicone antenna. For example, a low-pass filter placed within the bicone may allow lower frequencies to operate along the entire length of the antenna. At the same time, the low-pass filter may block higher frequencies to operate only in the region of the antenna between the feed point and the low-pass filter. Such an antenna may be said to exhibit frequency selective electrical length since the electrical length can change in response to operating frequency even though the physical length of the antenna may remain unchanged.

Impedance matching using an additional filter placed at the bicone feed input can provide a wider degree of latitude in the use of pattern tuning filters. Pattern tuning approaches that optimized pattern performance but sacrificed input impedance performance can be considered using this input filter. The input filter can be used to correct the input impedance for such approaches, yielding a more optimum solution in terms of both pattern tuning and input VSWR.

The discussion of bicone antennas presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

FIG. 1 illustrates a longitudinal bisection of a bicone antenna system with a pattern tuning filter and an input filter according to one exemplary embodiment of the present invention.

FIG. 2A illustrates an elevation view of a bicone antenna system with pattern tuning filters and input filtering for complex impedance matching according to one exemplary embodiment of the present invention.

FIG. 2B illustrates a pattern tuning filter element of a bicone antenna system according to one exemplary embodiment of the present invention.

FIG. 2C illustrates a tapered input filter for complex impedance matching according to one exemplary embodiment of the present invention.

FIG. 2D illustrates a tapered input filter for frequency selective, complex impedance matching according to one exemplary embodiment of the present invention.

FIG. 2E illustrates a lumped circuit input filter for frequency selective, complex impedance matching according to one exemplary embodiment of the present invention.

FIG. 3 illustrates an exploded view of a bicone antenna system according to one exemplary embodiment of the present invention.

FIG. 4 illustrates antenna radiation patterns of a bicone antenna system with and without pattern tuning filters according to one exemplary embodiment of the present invention.

FIG. 5 is a logical flow diagram of a process for improved VSWR operation of a high-impedance bicone antenna according to one exemplary embodiment of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION OF EXEMPLARY EMBODIMENTS

The present invention can support the design and operation of a bicone antenna with a reduced aperture or reduced cone angle; improved VSWR performance; frequency selective impedance matching; and frequency selective control of electrical length for radiation pattern tuning.

Pattern tuning filters can provide frequency selective control of electrical length and allow the antenna to exhibit two or more different electrical lengths where each length depends upon the operating frequencies of the signals. Simultaneous operation of the bicone antenna at varied electrical lengths for varied signal frequencies can provide for improved broadband performance of the antenna as well as improved radiation patterns. Improved broadband performance of the bicone can provide a single aperture antenna with improved radiation patterns at two or more varied frequency bands.

The bicone antenna may comprise a reduced aperture size achieved by reducing the cone angle. This reduction in cone angle can increase the impedance of the cones thus providing a high impedance bicone antenna system. Impedance matching provided by input filtering can be used to interface lower impedance inputs with the higher-impedance bicone elements.

Input filtering can provide frequency selective, complex impedance matching. Improved impedance matching may result in improved VSWR performance. Such filtering may be provided by a conductive taper positioned as the center conductor of a coaxial feed mechanism or other types of input filter mechanisms. The input filter can support a complex-to-complex impedance matching that varies with operating frequency to support the desired matching of input signals to the bicone antenna. Input filtering may permit the use of designs comprising combinations of pattern tuning filters and antenna characteristic impedance that could not otherwise be considered due to an unacceptable VSWR at the bicone input that would occur if the input filtering is not used.

The geometry of the cones may be modified to comprise an end section on one or both of the cones where the end segment is substantially cylindrical. This geometry can support an increase in aperture length without increasing the aperture diameter. The increase in length can support lower frequency operation.

While the antenna system may be referred to as specifically radiating or receiving, one of ordinary skill in the art will appreciate that the invention is widely applicable to both transmitting (exciting a medium) or receiving (be excited by a medium) without departure from the spirit or scope of the invention. Any portion of the description implying a single direction or sense of operation should be considered a non-limiting example. Such an example, that may imply a single sense or direction of operation, should be read to in fact include both directions, or senses, of operation in full accordance with the principle of electromagnetic reciprocity. In all cases, the antenna may both receive and transmit electromagnetic energy in support of communications applications or in electronic countermeasures.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

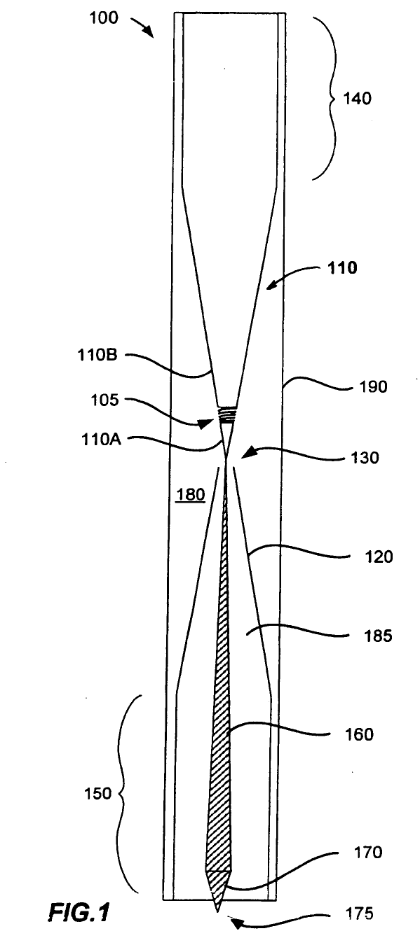

Turning now to FIG. 1, the figure illustrates a longitudinal bisection of a bicone antenna system 100 with a pattern tuning filter 105, and an impedance matching input filter 160 according to one exemplary embodiment of the present invention. The bicone antenna system 100 comprises an upper cone 110 and a lower cone 120. The upper cone can be separated into a proximal cone portion 110A and a distal cone portion 110B by a pattern tuning filter 105. This separation and filtering can allow the bicone antenna system 100 to operate as two bicone antennas within a single aperture. For example, with the pattern tuning filter 105 functioning substantially as a low-pass filter, higher frequency energy can be substantially confined to the proximal cone portion 110A. In contrast, lower frequency energy may pass the pattern tuning filter 105 thus exciting both the proximal cone portion 110A and the distal cone portion 110B. That is, a single antenna system 100 may operate as an antenna with a short electrical length at higher frequencies while also operating as an antenna with a long electrical length at lower frequencies.

The upper cone 110 and the lower cone 120 may each have reduced half-angles. For example, the half-angles of the cones may be less than thirty degrees, less than ten degrees, or even as small as three degrees or smaller. The half angle of a cone is the angle between the central axis of the cone and any side of the cone. The half-angle of the upper cone 110 may be greater than the half-angle of the lower cone 120. Such a difference may allow for the lower cone 120 to open near the central vertex 130 as illustrated. The half-angle of the upper cone 110 can also be substantially the same as or smaller than the half-angle of the lower cone 120.

This narrowing of the cones 110, 120 may reduce the aperture size of the bicone antenna 100 and also may increase the impedance of the antenna. One exemplary bicone antenna supports an operational bandwidth of 25 MHz to over 6 GHz and is characterized by a diameter of about 2 inches and an overall length of about 44 inches. This means that the height of each cone 110, 120 is about 22 inches. The VSWR over this frequency range can fall between 2:1 and 3:1. This 44-inch long bicone antenna system is considerably smaller than the traditional half wavelength design having a length of 236 inches at 25 MHz. The electrical aperture size can be reduced from the traditional half-wavelength to one-fifth-wavelength or smaller, for example.

To achieve this reduction in size, the bicone characteristic impedance may be increased. With the representative bicone dimensions discussed above, the impedance of the bicone antenna system can be around 306 ohms. This increased impedance characteristic of the bicone antenna system may be mismatched at the signal feed, such as a typical 50 ohm coaxial feed line. This impedance mismatch is addressed in more detail below.

An impedance mismatch between the bicone antenna elements 110, 120 and the feed line connecting to the antenna system 100, as well as inductance that may be introduced by pattern tuning filters 105, may be mitigated by an impedance matching input filter 160. The impedance matching input filter 160 may be provided by a conductive matching taper 160 provided within the antenna system 100. Generally, a high impedance bicone antenna may have an impedance of about 90 ohms or higher. For example, the exemplary bicone geometry discussed above can exhibit impedances of about 306 ohms. Meanwhile, the most common form of feed line is a 50 ohm coaxial cable, commonly referred to as “coax.” The matching taper 160 may be a conductive tape connecting with the top cone 110 at the central vertex 130 of the antenna system. The matching taper 160 may be welded, soldered, press-fit into or otherwise attached to the upper cone.

At the central vertex 130 of the antenna system 100, the matching taper 160 can be very narrow and may continuously expand towards the bottom of the lower cone 120. Varying the width of the matching taper 160 can control the impedance. Greater widths produce smaller impedances, and smaller widths produce larger impedances, so the width of the matching taper 160 near the high impedance central vertex 130 is narrower than the width of the impedance matching taper 160 near the lower impedance feed line. Other impedance matching structures 160 may be employed. For example, the impedance matching taper 160 may be an exponential taper, a Klopfenstein taper, a continuous taper, or any other type of matching taper. Also, the impedance matching input taper 160 may be coax, or other transmission line as well as conical waveguide, circular waveguide, or other waveguide. The impedance matching input taper 160 may also comprise lumped filter elements, circuit elements with or without supporting circuit boards, microstrip circuits, stripline circuits, active filters, passive filters, or any other filter mechanisms. Some additional examples of impedance matching input tapers 160 are discussed in more detail below.

At the bottom, or widest region, of the impedance matching taper 160, a reduction coupler 170 may be provided to reduce the radius of the impedance matching taper 160. The reduction coupler 170 may reduce the radius of the impedance matching taper 160 to allow the application of a connector 175 to the impedance matching taper 160. The connector 175 can provide a connection point between a feed line and the bicone antenna system 100. The connector 175 may be coaxial, N-type, F-type, BNC, waveguide flange, solder terminals, compression fitting, or any other mechanism for connecting a feed line into the antenna system 100.

The impedance matching taper 160 can generally be formed of any conductive material such as copper, aluminum, silver, bronze, brass, any other metal, metallized substrate, or any mixture and/or alloy thereof. The impedance matching taper 160 may be layered, plated, or solid. In one example, the impedance matching taper 160 can be formed from a solid metal part with a rectangular cross-section having a thickness of about 0.025 inches.

While the common 50 ohm coax has been discussed as an example, other types of feed line may be used with the antenna system 100. For example, coax, ladder line, rectangular waveguide, circular waveguide, conical waveguide, or other waveguides and/or cables may be used to feed the bicone antenna system 100. Also, the bicone may be directly fed by a high-impedance transmission line.

The volume within the lower cone 120 can contain a dielectric 185. The dielectric 185 can be a foam with a low dielectric constant. The dielectric 185 can provide mechanical support for the impedance matching taper 160. Such mechanical support may operate to position the impedance matching taper 160 in the center of the lower cone 120 in order to maintain the desired impedance. A dielectric 185 with a low dielectric constant may be useful to reduce multi-mode propagation along the impedance matching taper 160 within the lower cone 120. A dielectric 185 with a low dielectric constant may also be useful in supporting higher frequency performance of the antenna system 100. The dielectric 185 may be a polyethylene foam, a polystyrene foam, a foam of some other polymer or plastic, or a solid dielectric. The dielectric 185 may also be a non-continuous structure such as ribs, braces, or trussing that can be formed of plastic, polymer, fiberglass composite, glass, or some other dielectric, for example.

The cones 110, 120 of the antenna system 100 can generally be implemented by any conductive material such as copper, aluminum, silver, bronze, brass, any other metal, metallized substrate, or any mixture and/or alloy thereof. The conductive material of the cones 110/120 may be layered, plated, solid, mesh, wire array, metallized insulator, or foil, as examples.

The cones 110, 120 may be protected from the external environment by a radome 190 that covers or encloses the cones 110, 120. A radome 190 is typically implemented by a structural enclosure useful for protecting an antenna from the external effects of its operating environment. For example, a radome 190 can be used to protect the surfaces of the antenna from the effects of environmental exposure such as wind, rain, sand, sunlight, and/or ice. A radome 190 may also conceal the antenna from public view. The radome 190 is typically transparent to electromagnetic radiation over the operating frequency range of the antenna. The radome 190 can be constructed using various materials such as fiberglass composite, TEFLON coated fabric, plastic, polymers, or any other material or mixture of materials that can maintain the desired level of radio transparency.

The area between the radome 190 and the cones 110, 120 can contain a dielectric 180. The dielectric 180 can be a foam with a low dielectric constant. The dielectric 180 can provide mechanical support for the cones 110, 120. Such mechanical support may operate to position and buffer the cones 110, 120 within the radome 190. A dielectric 180 with a low dielectric constant may be useful in maintaining the high impedance properties of the bicone antenna. The dielectric 180 may be a polyethylene foam, a polystyrene foam, a foam of some other polymer or plastic, or a solid dielectric. The dielectric 180 may also be a non-continuous structure such as ribs, braces, or trussing that can be formed of plastic, polymer, fiberglass composite, glass, or some other dielectric, for example.

While the dielectric 180 and the dielectric 185 may be the same material, they need not be identical in a specific application. For both dielectric 180 and dielectric 185, a low dielectric constant is typically desired. For example, a dielectric constant of less than about two may be used for either dielectric 180 or dielectric 185. One or both of dielectric 180 and dielectric 185 may also be air.

When the central vertex 130 of the antenna system 100 is fed by a single conductor, such as the single strip, impedance matching taper 160, the inside surface of the lower cone 120 may function as the outside conductor, or the return. That is, the conductive taper 160 used for impedance matching can be considered the center conductor of a coaxial feed mechanism where the inside of the lower cone 120 can serve as the outside conductor (or shielding conductor, or return) of the tapered feed 160.

The upper cone 110 can include an extension 140 where the extension may be cylindrical and may have a diameter substantially equal to widest opening of the upper cone 110. The lower cone 120 can include an extension 150 where the extension may be cylindrical and may have a diameter substantially equal to the widest opening of the lower cone 120. Such extensions 140, 150 can support an increase in aperture length without increasing the aperture diameter. This increase in length can support lower frequency operation. In addition to being substantially cylindrical, the extensions 140, 150 may also have a smaller half-angle than the respective cone 110, 120 which it is extending. A cylinder can be considered the limiting case of reducing the half-angle of the radiator.

The addition of a cylindrical or reduced angle extension 140, 150 to a respective cone 110, 120 may be considered forming a cone with two segments of differing angles. Each cone 110, 120 may have 1, 2, 3, 4, 5, or more such segments. That is, each cone 110, 120 may have one or more extensions 140,150. The two cones 110,120 need not have the same number of segments or the same number of extensions 140, 150. The number of extensions 140, 150 to either or both cones 110, 120 may also be zero.

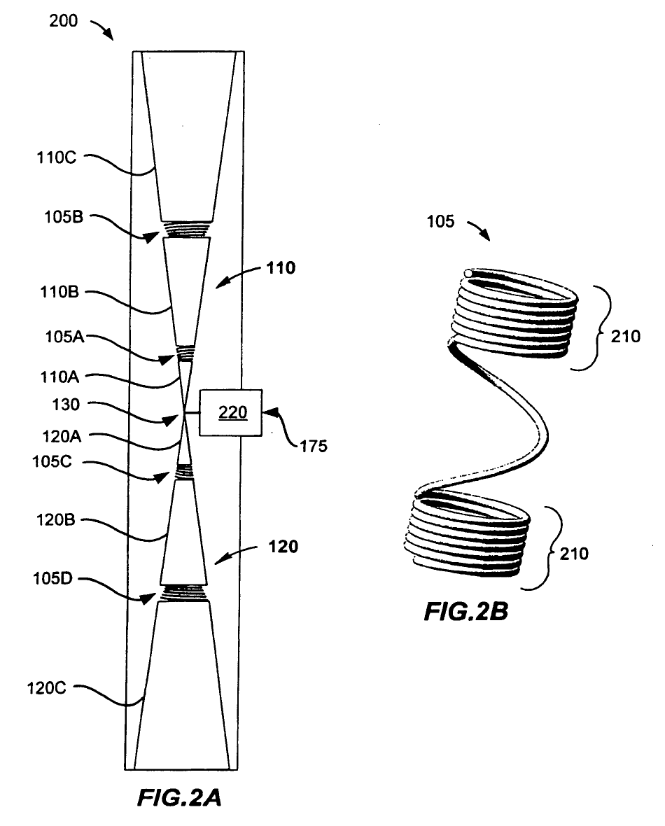

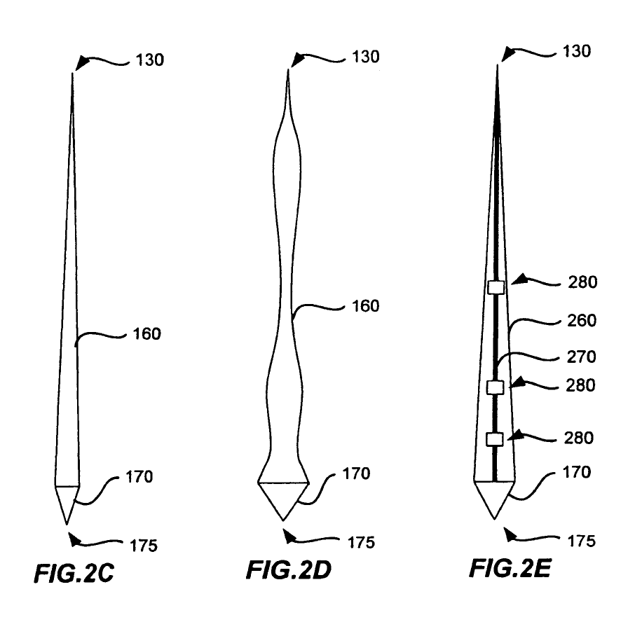

The separation of the upper cone 110 into a proximal cone portion 110A and a distal cone portion 110B can be made at any point within the upper cone 110 or the upper extension 140 that is advantageous to the high frequency operation of the bicone antenna system 100. Such separation and insertion of filter elements 105 may also occur at multiple points along the upper cone 110. These separations may also occur in the lower cone 120 or lower extension 150. Multiple separation and filtering nodes in both the upper cone 110 and the lower cone 120 are discussed in more detail with relation to FIG. 2A. The use of multiple filters at differing lengths may allow the antenna system 100 to have different electrical lengths for two or more frequency bands of operation.

Throughout the discussion of the figures, the conical antenna elements 110, 120 are referred to as the upper cone 110 and the lower cone 120 for consistency. One of ordinary skill in the art will appreciate, however, that the common axis of the conical structures may be vertical, horizontal, or at any desired angle without departing from the scope or spirit of the present invention. That is, the cones may be side-by-side or the upper cone 110 may be positioned below the lower cone 120.

Turning now to FIG. 2A, the figure illustrates an elevation view of a bicone antenna system 200 with four pattern tuning filters 105A-105D, and input filtering 220 for complex impedance matching according to one exemplary embodiment of the present invention. The upper cone 110 may be separated into three portions, a proximal upper cone portion 110A, a middle upper cone portion 110B, and a distal upper cone portion 110C. Similarly, the lower cone 120 may be separated into three portions, a proximal lower cone portion 120A, a middle lower cone portion 120B, and a distal lower cone portion 120C. The bicone antenna 200 can be fed from the center point 130. A feed line may be connected to the antenna 200 at the center point 130 where the upper and lower cones meet.

A low-pass filter 105A can be used to separate the proximal upper cone portion 110A from the middle upper cone portion 110B. Similarly, a low-pass filter 105C can be used to separate the proximal lower cone portion 120A from the middle lower cone portion 120B. The crossover frequency from the pass band to the stop band of the filter elements 105A and 105C may be selected so that a higher frequency signal is blocked by the filter elements 105A and 105C. This blocking may substantially confine the higher frequency signal to the central region of the antenna 100 comprising the proximal upper cone portion 110A and the proximal lower cone portion 120A. Confining the signal to this central region can reduce the electrical length of the antenna 200 at the higher frequencies.

A low-pass filter 105B can be used to separate the middle upper cone portion 110B from the distal upper cone portion 110C. Similarly, a low-pass filter 105D can be used to separate the middle lower cone portion 120B from the distal lower cone portion 120C. The crossover frequency from the pass band to the stop band of the filter elements 105B and 105D may be at lower frequencies than the crossover frequency of the filter elements 105A and 105C. The crossover frequency from the pass band to the stop band of the filter elements 105B and 105D may be selected so that a mid range frequency signal is blocked by the filter elements 105B and 105D, yet passed by the filter elements 105A and 105C. This filtering may substantially confine the higher frequency signal to the central and middle regions of the antenna 200 comprising the proximal upper cone portion 110A, the middle upper cone portion 110B, the proximal lower cone portion 120A, and the middle lower cone portion 120B. Confining the signal to the central and middle regions can increase the electrical length of the antenna 200 over the electrical length in the high frequency case discussed above, but still maintain an electrical length reduced from the full length of the antenna 100. This could be considered a medium electrical length. Low frequency signals below the crossover point of the filter elements 105B and 105D may not be constrained and instead may excite the entire length of the antenna 100. Operation in these lower frequency bands may imply a longer electrical length than both of the reduced cases discussed above.

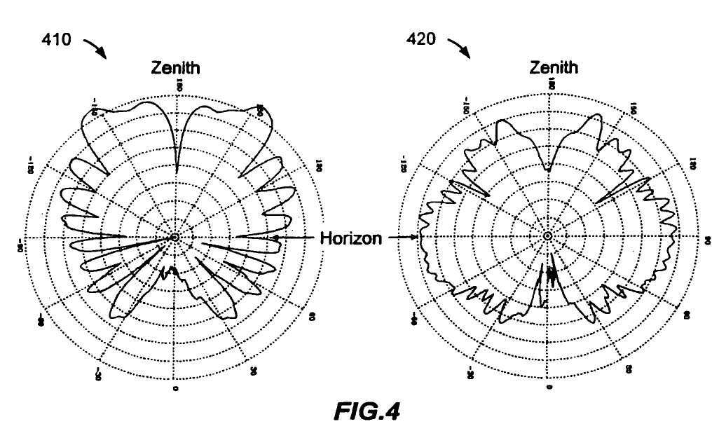

The separation of each of the cones 110, 120 into three sections using pattern tuning filters 105 may be said to divide the antenna 200 in three separate electrical lengths. The respective electrical lengths may be selected by the frequency of the signals and their relationship to the crossover frequencies of the pattern tuning filters 105. These crossover frequencies can be designed to correspond to the desired electrical lengths for the antenna 200 within different bands of operating frequency. Operating one of the electrical lengths in response to the associated frequency band can provide for improved radiation patterns as discussed in further detail with respect to FIG. 4 below. While the pattern tuning filters 105 may provide this improved radiation pattern performance, they can also provide increased inductance that changes input impedance matching in either a constructive or destructive manner.

While the example illustrated comprises two pattern tuning filters 105 within each cone 110, 120 to separate each cone 110, 120 into three portions, there could be any number of filters placed within the cone 110, 120 to provide various different electrical lengths, and those improve radiation patterns, within the same antenna 100. Additionally, the quantity and placement of the pattern tuning filters 105 within the upper cone 110 and within the lower cone 120 may not be identical. There may be more pattern tuning filters 105 within the upper cone 110 than in the lower cone 120, or there may be fewer, none, or the same number. The pattern tuning filters 105 in the upper cone 110 may be positioned at intervals along the cone that are symmetrical with the placement of the pattern tuning filters 105 along the lower cone 120. The positioning of the pattern tuning filters 105 within the upper 110 cone may also be asymmetrical with respect to the positioning of the pattern tuning filters 105 within the lower cone 120.

The input impedance matching filter 220 may provide frequency dependent matching between the feed line and the bicone antenna 200 through a feed connector 175. Such matching can improve VSWR performance of the bicone antenna system 200. In addition to providing matching between two real impedances, an impedance matching input filter 220 may provide complex-to-complex impedance matching. Additional examples of input impedance matching filters 220 are discussed in more detail below with respect to FIG. 2C-2E. The impedance matching filter 220 may connect with the central feedpoint 130 of the bicone antenna 200 through the center or axis of one the cones as illustrated for the impedance matching taper 160 in FIG. 1, or the connection may be from outside of the cones as illustrated in FIG. 2A.

Turning now to FIG. 2B, the figure illustrates a pattern tuning filter 105 of a bicone antenna system according to one exemplary embodiment of the present invention. The pattern tuning filter 105 may be an inductive coil or conductive helix. The coil may be formed of a stiff conductor wound into a coil similar to a spring. A spring-like pattern tuning filter 105 may reduce mechanical rigidity and thus provide increased mechanical robustness to the antenna system 100. One, or more, end regions 210 of the pattern tuning filter 105 may be tightly wound. The interior surface of such an end region 210 of the pattern tuning filter 105 may serve as a threaded void for accepting a short threaded shaft or threaded rod. Such threaded coupling may provide an exemplary mating between the pattern tuning filter 105 and the cone portions that the pattern tuning filter 105 joins. A substantially cylindrical protrusion from a cone portion may have a thread cut or chased onto it to substantially match the pitch of the coiling within an end region 210 of a pattern tuning filter 105. Thus, the pattern tuning filter 105 may be mated, by threading, to the cone portion. Such mating may also be achieved by welding, soldering, bolting, riveting, compression, adhesive, otherwise, or any combination thereof, as non-limiting examples. Additionally, the cone portions and the pattern tuning filters 105 may be formed from a singular blank, molding, or casting.

The pattern tuning filters 105 may operate substantially as an electrical low-pass filter. Other frequency responses (such as high-pass, band-pass, band-stop, linear, non-linear, or any combination thereof) may be provided by the pattern tuning filters 105 as suitable for the frequency selective electrical length and desired radiation patterns of the bicone antenna system 100. Furthermore, the crossover frequencies of the filters 105 may be sharp or roll off gradually. The pattern tuning filters 105 may be inductive, capacitive, lumped, distributed, singular, multiple, in series, in parallel, circuit board, or any combination thereof. The antenna system 100 may comprise multiple pattern tuning filters 105 at multiple points along one or both cones 110, 120 and the filters may be the same as one another or different from one another.

Turning now to FIG. 2C, the figure illustrates a tapered input filter 160 for complex impedance matching according to one exemplary embodiment of the present invention. The matching taper 160 can serve as an impedance matching input filter 220. An impedance mismatch between the bicone antenna elements 110, 120 and the feed line connecting to the exemplary antenna system 100, as well as inductance that may be introduced by pattern tuning filters 105, may be mitigated by a tapered input filter 160. The distributed impedance over the length of the taper 160 may determine the reflection coefficient provided by the matching at a given frequency. As an example of frequency dependent impedance matching, the taper 160 becomes more reactive at lower operative frequencies. This reactive property of the taper can improve signal matching and the VSWR performance of the bicone antenna system 100, especially at lower frequencies.

At the central vertex 130 of the antenna system 100, the matching taper 160 can be very narrow and may continuously expand towards the bottom of the lower cone 120. At the bottom, or widest region, of the impedance matching taper 160, a reduction coupler 170 may be provided to reduce the radius of the impedance matching taper 160. The reduction coupler 170 may reduce the radius of the impedance matching taper 160 to allow the application of a feed connector 175 to the impedance matching taper 160. The feed connector 175 can provide a connection point between a feed line and the bicone antenna system 100. The feed connector 175 may be coaxial, N-type, F-type, BNC, waveguide flange, solder terminals, compression fitting, or any other mechanism for connecting a feed line into the antenna system 100.

The impedance matching taper 160 can generally be formed of any conductive material such as copper, aluminum, silver, bronze, brass, any other metal, metallized substrate, or any mixture and/or alloy thereof. The impedance matching taper 160 may be layered, plated, or solid. In one example, the impedance matching taper 160 can be formed from a solid metal part with a rectangular cross-section having a thickness of about 0.025 inches.

Turning now to FIG. 2D, the figure illustrates a tapered input filter 160 for complex impedance matching according to one exemplary embodiment of the present invention. The matching taper 160 can serve as an impedance matching input filter 220. An impedance mismatch between the bicone antenna elements 110, 120 and the feed line connecting to the exemplary antenna system 100, as well as inductance that may be introduced by pattern tuning filters 105, may be mitigated by a tapered input filter 160. The distributed impedance over the length of the taper 160 may determine the reflection coefficient provided by the matching at a given frequency. As an example of frequency dependent impedance matching, the taper 160 becomes more reactive at lower operative frequencies. This reactive property of the taper can improve signal matching and the VSWR performance of the bicone antenna system 100, especially at lower frequencies. The shaping of the taper can be adjusted to tune the impedance matching characteristics of the taper as a function of operating frequency. Such tuning can specifically match the impedances of the feed line at connector 175 to the impedances of the bicone antenna 100 over a range of frequencies even if the impedance matching varies with frequency. The tuning of the taper 160 can also mitigate mismatch introduced into the bicone antenna 100 by the inclusion of pattern turning filters 105, such as added inductance from coil-like pattern tuning filters 105.

At the central vertex 130 of the antenna system 100, the matching taper 160 can be very narrow and may continuously expand towards the bottom of the lower cone 120. At the bottom, or widest region, of the impedance matching taper 160, a reduction coupler 170 may be provided to reduce the radius of the impedance matching taper 160. The reduction coupler 170 may reduce the radius of the impedance matching taper 160 to allow the application of a feed connector 175 to the impedance matching taper 160. The feed connector 175 can provide a connection point between a feed line and the bicone antenna system 100. The feed connector 175 may be coaxial, N-type, F-type, BNC, waveguide flange, solder terminals, compression fitting, or any other mechanism for connecting a feed line into the antenna system 100.

Turning now to FIG. 2E, the figure illustrates a lumped circuit input filter 260 for complex impedance matching according to one exemplary embodiment of the present invention. The matching filter 260 can serve as an impedance matching input filter 220. An impedance mismatch between the bicone antenna elements 110, 120 and the feed line connecting to the exemplary antenna system 100, as well as inductance that may be introduced by pattern tuning filters 105, may be mitigated by the matching filter 260.

The matching filter 260 can be comprise conductive traces, microstrip, stripline, waveguide, or other transmission mechanism supported by a printed circuit board. Other transmission mechanisms not supported by printed circuit board may also be used in the matching filter 260. The matching filter 260 can comprise any number of lumped circuit elements 280 interconnected by conductors or waveguides 270. The lumped circuit elements 280 can make up any types of input matching filter 220 as required by the design of the bicone antenna system 100. The lumped circuit elements 280 may be passive or active. In addition to providing matching between two real impedances, an impedance matching input filter 220 may provide complex-to-complex impedance matching. The complex-to-complex impedance matching may vary with respect to operating frequency thus providing full frequency dependent matching.

The matching filter 260 can extend from the central vertex 130 of the antenna system 100 to the bottom of the lower cone 120 where a coupler 170 may allow the application of a feed connector 175. The feed connector 175 can provide a connection point between a feed line and the bicone antenna system 100. The feed connector 175 may be coaxial, N-type, F-type, BNC, waveguide flange, solder terminals, compression fitting, or any other mechanism for connecting a feed line into the antenna system 100. The matching filter 260 may also connect to the central vertex 130 of the bicone antenna system 100 from between the cones as illustrated for the impedance matching input filter 220 in FIG. 2A.

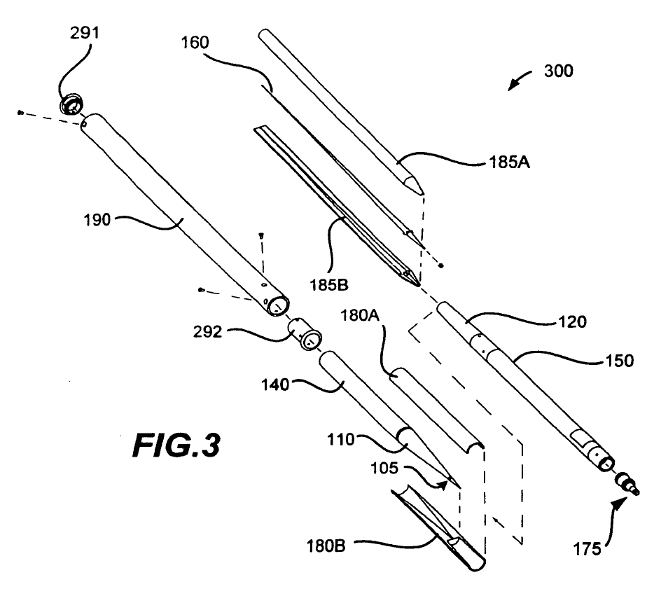

Turning now to FIG. 3, the figure illustrates an exploded view of a bicone antenna system 300 according to one exemplary embodiment of the present invention. The upper cone 110 may continue into an extension 140. The upper cone 110 may include a pattern tuning filter 105. Both the upper cone 110 and the lower cone 120 may be formed by molding, casting, stamping, milling, machining, rolling, cutting or any other technique for forming.

An impedance matching taper 160 can provide the input impedance matching filter 220. The matching taper 160 may be connected at its tip to the tip of the upper cone 110. The impedance matching taper 160 can be supported within the lower cone 120 by a dielectric 185, which FIG. 3 exemplarily illustrates as two halves 185A, 185B (collectively 185).

In one exemplary embodiment, the dielectric 185 can be a series of dielectric ribs. In one exemplary embodiment, the dielectric 185 can be a foam with a low dielectric constant. The foam dielectric 185 can be provided as a single element or as a first half 185A and a second half 185B. The impedance matching taper 160 can be connected at its lower impedance end to a connector 175 for attaching a feed line to the antenna system 300.

A dielectric 180, which FIG. 3 exemplarily illustrates as two halves 180A, 180B (collectively 180), can provide mechanical support around the cones 110, 120. Such mechanical support may operate to position and buffer the cones 110, 120 within a radome 190. The dielectric 180 can be formed of a first half 180A and second half 180B. The dielectric 180 can also be formed by a single element. The dielectric 180 can be a foam that is thermally or chemically set in place around the cones 110, 120. The dielectric 180 can also be molded, machined, or otherwise formed.

The antenna system 300 may be assembled such that the impedance matching taper 160 and its supporting dielectric 185 are formed into the lower cone 120 and the lower cone extension 150. The connector 175 may be pressed or otherwise attached into the distal end of the lower cone extension 150 in order to electrically communicate with the impedance matching taper 160. The lower cone 120 and the upper cone 110 can come together such that the high impedance end of the impedance matching taper 160 engages with the vertex of the upper cone 110. The combined cones 110, 120; their extension tubes 140, 150; and the surrounding dielectric 180 may then be formed into the radome 190. A coupling collar 292 may be used to mechanically support an interface between the radome 190 and the lower cone extension 150 such that the radome 190 and the lower cone extension 150 become the predominate external elements of the fully assembled system. An end cap 291 may close off the top end of the radome 190. These assembly steps may provide for a rugged and robust bicone antenna system 300 that may be efficiently manufactured and assembled to reduce material handing and manufacturing costs.

Turning now to FIG. 4, this figure illustrates antenna radiation patterns of a bicone antenna system 100 both with and without pattern tuning filters 105 according to one exemplary embodiment of the present invention. Plot 410 illustrates the radiation pattern without pattern tuning filters 105 with high frequency operation. Since the electrical length of the non-filtered antenna system can be longer than ideal for higher frequency operation, undesirable radiation characteristics may result. Increased energy may be radiated upward towards the zenith while nulls in the radiation pattern may develop along the horizon where maximum energy may be desired.

Plot 420 illustrates the radiation pattern with the filters in place. With pattern tuning filters 105 in place, the electrical length of the antenna system 100 may be reduced for high frequency operation. This reduced electrical length may be beneficial to prevent excessive energy from radiating skyward toward the zenith and can also substantially reduce the nulls near the horizon.

While the inclusion of the pattern tuning filters 105 can improve the radiation pattern shaping at different frequencies, and the impedance matching input filter 220 can improve the signal matching or VSWR to couple RF energy into the antenna system, the combination and mutual tuning of these filters along with the impedance of the bicone antenna elements can improve the overall performance of the bicone antenna system 100 over a broad range of operating frequencies. Such tuning may be carried out using computer simulation or empirical testing and may involve an iterative design process to tune the various elements of the antenna system 100 according to desired performance of various metrics such as aperture size, weight, frequencies of operation, bandwidths of operation, desired radiation pattern, desired VSWR, feed line characteristics, feed system characteristics, operating environment, and various other communication system parameters.

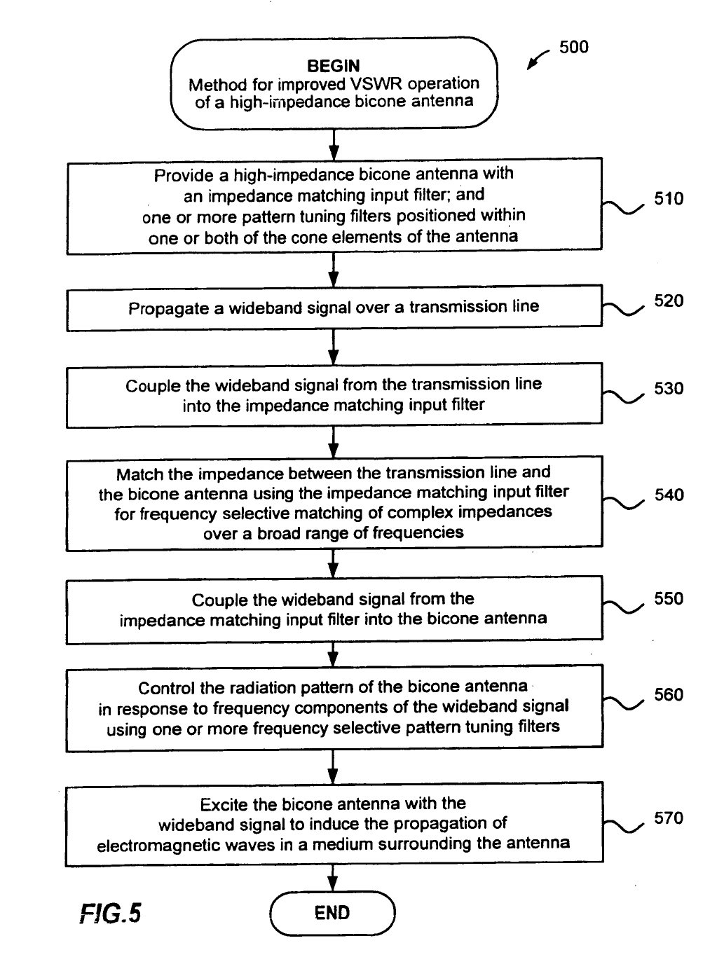

Turning now to FIG. 5, the figure shows a logical flow diagram 500 of a process for improved VSWR operation of a high-impedance bicone antenna 100 according to one exemplary embodiment of the present invention. Certain steps in the processes or process flow described in the logic flow diagram referred to below must naturally precede others for the invention to function as described. However, the invention is not limited to the order of the steps described if such order or sequence does not alter the functionality of the invention. That is, it is recognized that some steps may be performed before, after, or in parallel with other steps without departing from the scope or spirit of the invention.

In Step 510, a bicone antenna is provided for a communications application, i.e., transmission and/or reception of electromagnetic signals. The bicone antenna 100 may have an increased impedance, reduced aperture size, and/or reduced cone angle. The bicone antenna 100 may comprise an impedance matching input filter 220. The bicone antenna 100 may comprise one or more pattern tuning filters 105 positioned within one or both of the cone elements of the antenna 100.

In Step 520, a wideband signal can be propagated over a transmission line.

In Step 530, the wideband signal can be coupled from the transmission line into the impedance matching input filter 220. The signal coupling into the impedance matching input filter 220 may employ a connector 175. The impedance matching input filter 220 may comprise an impedance matching taper 160. The impedance matching filter 220 may also be any other filter or mechanism for impedance matching, such as lumped filters, active filters, passive filters, or any other type of filter or impedance matching mechanism.

In Step 540 the impedance can be matched between the transmission line and the bicone antenna 100 using an impedance matching input filter 220. The impedance matching input filter 220 may provide frequency dependent impedance matching over a broad range of frequencies. The impedance matching input filter 220 may provide for complex-to-complex impedance matching.

In Step 550, the wideband signal can be coupled from the impedance matching input filter 220 into the bicone antenna 100. The coupling from the impedance matching input filter 220 into the bicone antenna 100 can occur at the central feedpoint 130 of the bicone antenna 100. The impedance matching input filter 220 may connect with the central feedpoint 130 from the inside or axis of one of the cones from the outside of the cones.

In Step 560, the pattern turning filters 105 within the bicone antenna 100 may be used to alter the electrical length and/or the radiation pattern of the bicone antenna 100 in response to the frequency components of the wideband signal.

High frequency components of the wideband signal can be restricted to a reduced length of the bicone antenna. This restriction can be in response to one or more of the pattern tuning filters providing electrical open-circuits at high frequencies. For example, a low-pass filter can act as an open-circuit, or a high resistance, high reactance, or other high attenuation with respect to high frequency signals.

Similarly, low frequency components of the wideband signal can be permitted to an increased length of the bicone antenna. This propagation can be in response to one or more of the pattern tuning filters providing electrical short-circuits at low frequencies. For example, a low-pass filter can act as a short-circuit, or a low resistance, low reactance, or other low attenuation with respect to low frequency signals.

In Step 570, the wideband signal coupled into the bicone antenna 100 can excite the bicone antenna 100 as to induce the propagation of electromagnetic waves from the bicone antenna 100 into a medium surrounding the bicone antenna 100. The exemplary process 500, while possibly operated continuously, may be considered complete after Step 570.

Although the process 500 is described above with one or more pattern tuning filters 105 providing two diverse electrical lengths for the bicone antenna 100, additional pattern tuning filters 105 may be similarly employed to provide more than two diverse electrical lengths within a single antenna 100. One example may include N pattern tuning filters 105 within either or both cones to provide N+1 diverse electrical lengths. Such an arrangement of N+1 electrical lengths may improve performance for each of N+1 different bands of operating frequencies.

Although the process 500 is described above in connection with the radiation or transmission of an electromagnetic signal, the process 500 may also be operated in reverse due to electromagnetic reciprocity. Such reverse operation of process 500 may be considered signal reception where the antenna 100 operates as a receiving antenna that is excited by the surrounding medium instead of exciting the surrounding medium.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims that follow.

What is claimed is:

1. An antenna system comprising:
a first conductive element comprising a first substantially conical geometry;
a second conductive element comprising a second substantially conical geometry and positioned on a common axis with the first conductive element to form a bicone antenna;
a first filter in electrical communication with the first conductive element for frequency selective tuning of a radiation pattern of the antenna system; and
a second filter in electrical communication with a central feed point of the bicone antenna for impedance matching into the antenna system, wherein the bicone antenna, the first filter, and the second filter are mutually tuned to achieve a reduction in a voltage standing wave ratio of the antenna system.

2. The antenna system of claim 1, wherein the first substantially conical geometry has a half angle of less than ten degrees, and the second substantially conical geometry has a half angle of less than ten degrees.

3. The antenna system of claim 1, wherein the bicone antenna has a characteristic impedance greater than 90 ohms.

4. The antenna system of claim 1, wherein an aperture size of the bicone antenna is less than one fifth of a lowest operating wavelength of the bicone antenna.

5. The antenna system of claim 1, wherein the first filter comprises a low-pass filter.

6. The antenna system of claim 1, wherein the first filter comprises an inductor.

7. The antenna system of claim 1, wherein the second filter comprises a tapered conductive strip.

8. The antenna system of claim 1, wherein the second filter comprises lumped filter components.

9. The antenna system of claim 1, wherein the second filter supports frequency selective impedance matching of complex impedances.

10. An antenna system comprising:
a first conductive cone element;
a second conductive cone element positioned on a common axis with the first conductive cone element to form a bicone antenna comprising a first length of the bicone antenna along the common axis; and
a filter in electrical communication with a central feed point of the bicone antenna for frequency selective impedance matching into the bicone antenna, wherein the bicone antenna, and the filter are mutually tuned to achieve a reduction in a voltage standing wave ratio of the antenna system.

11. The antenna system of claim 10, wherein the first conductive cone element has a half angle of less than ten degrees, and the second conductive cone element has a half angle of less than ten degrees.

12. The antenna system of claim 10, wherein the bicone antenna has a characteristic impedance greater than 90 ohms.

13. The antenna system of claim 10, wherein an aperture size of the bicone antenna is less than one fifth of a lowest operating wavelength of the bicone antenna.

14. The antenna system of claim 10, further comprising one or more filters disposed within the bicone antenna, along the first length of the bicone antenna, for turning a radiation pattern of the antenna system.

15. The antenna system of claim 14, wherein the one or more filters comprise inductive coils.

16. The antenna system of claim 10, wherein the filter comprises a tapered conductive strip.

17. The antenna system of claim 10, wherein the filter comprises lumped filter components.

18. The antenna system of claim 10, wherein the filter supports matching of complex impedances.

19. A method for improved voltage standing wave ratio operation of a bicone antenna system comprising the steps of:
providing a high-impedance bicone antenna, an impedance matching input filter in electrical communication with the high-impedance bicone antenna, and one or more pattern tuning filters positioned within one or both conductive cone elements of the bicone antenna;
matching the impedance between the bicone antenna and a transmission line feeding the bicone antenna using the impedance matching input filter to provide frequency selective matching of complex impedances over a broad range of operating frequencies;
controlling a radiation pattern of the bicone antenna using one or more frequency selective pattern tuning filters in response to bands of the operating frequencies;
mutually tuning a characteristic impedance of the bicone antenna, a frequency selective response of the impedance matching input filter, and respective response characteristics of the one or more pattern matching filters to substantially reduce the voltage standing wave ratio of the bicone antenna system; and
exciting the bicone antenna to induce the propagation of electromagnetic waves in a medium surrounding the antenna.

20. The method of claim 19, wherein the step of controlling a radiation pattern of the bicone antenna comprises providing frequency selective control of an electrical length of the bicone antenna.

21. An antenna system comprising:
a conductive cone antenna element comprising a base, a vertex, and an input port leading to the vertex; and
a filter electrically connected to the input port for frequency selective impedance matching into the conductive cone antenna element,
wherein the conductive cone antenna element and the filter are collectively tuned for managing voltage standing wave ratio of the antenna system.

22. The antenna system of claim 21, wherein the filter and the conductive cone antenna element are further tuned for reducing voltage standing wave ratio of the antenna system.

23. The antenna system of claim 21, wherein the filter and the conductive cone antenna provide the antenna system a first voltage standing wave ratio that is substantially lower than a second voltage standing wave ratio of the conductive cone operated without the filter.
